(19) United States
(12) Patent Application Publication
(10) Pub. No.: US 2010/0031466 A1
(43) Pub. Date: Feb. 11, 2010

(54) BLADE MEMBER

(75) Inventors: Shuji ABE, Tokyo (JP); Miyuki Ueno, Tokyo (JP)

Correspondence Address: YOUNG & THOMPSON, 209 Madison Street, Suite 500, Alexandria, VA, 22314, US

(73) Assignee: SYNZTEC CO., LTD., TOKYO (JP)

(21) Appl. No.: 12/348,113

(22) Filed: Jan. 2, 2009

(30) Foreign Application Priority Data
Jan. 15, 2008 (JP) 2008-006171
Dec. 3, 2008 (JP) 2008-308804

(51) Int. Cl. G03G 21/00

(52) U.S. Cl. 15/256.5; 399/350

(57) ABSTRACT

The blade member is formed of a polyurethane member produced through curing and molding a castable polyurethane composition containing at least a polyol, an isocyanate compound, and a cross-linking agent. The polyurethane member exhibits a storage modulus (1 Hz) as measured at 40° C. of 2.0×10⁷ Pa or higher and a (G′10)/(G′50) of 3 or lower, wherein represents a storage modulus (1 Hz) as measured at 10° C. (Pa) and G′50 represents a storage modulus (1 Hz) as measured at 50° C. (Pa).

The entire disclosures of Japanese Patent Applications Nos. 2008-006171 filed Jan. 15, 2008 and 2008-308804 filed Dec. 3, 2008 are expressly incorporated by reference herein.

### BACKGROUND OF THE INVENTION

1. Field of the Invention

The present invention relates to a blade member and, more particularly, to a blade member suitably used as, for example, a cleaning blade member for removing toner deposited on a toner image carrier employed in an electrophotographic process such as a photoreceptor or a transfer belt, on which a toner image is formed and which transfers the formed image to an image receptor, or a printing squeegee.

2. Background Art

Generally, in an electrophotographic process, electrophotographic apparatus parts such as an electrophotographic photoreceptor and a transfer belt are used cyclically and repeatedly, and toner deposited thereon is removed by means of a cleaning blade. The cleaning blade, which generally comes into contact with a photoreceptor over a long period of time, is required to have excellent wear resistance and a low friction coefficient. When the cleaning blade is in contact with a photoreceptor, friction induces vibration in the cleaning blade, thereby generating anomalous noises (a buzzing noise, a squeaky noise, etch), which is problematic.

Thus, a variety of countermeasures have been taken against squeaky sound. For example, there have been proposed a cleaning blade having a layered structure in which a plurality of layers of different materials are stacked in the thickness direction and a layer on the cleaning edge side is formed from a high-hardness resin (see Japanese Patent Application Laid-Open (kokai) No. 2004-84462), and a cleaning blade formed of a thermosetting elastomer composition containing a rubber component (A), a filler (B), and a cross-linking agent (C), wherein the type and amount of the filler (B) and the cross-linking agent (C) are adjusted, to thereby prevent generation of squeaky sound (see Japanese Patent Application Laid-Open (kokai) No. 2007-41454).

Other problems include high production cost of blades due to a number of production steps, and unsatisfactory blade characteristics.

Furthermore, in response to the recent trend toward attaining a prolonged service life of units employed in electrophotographic apparatuses, photoreceptors have now a long service life. Thus, the blade must also have high durability.

There has been developed a cleaning blade formed of a cured polyurethane exhibiting a tensile strength as measured at 50° C. of 12 MPa or higher, a tan δ peak temperature of 15° C. or lower, and a hardness of 80° or lower (see Japanese Patent Application Laid-Open (kokai) No. 2001-265190). As disclosed in Japanese Patent Application Laid-Open (kokai) No. 2001-265190, the peak temperature and intensity of tan δ have been regulated in order to improve variation in physical properties with temperature. However, when only the peak temperature and intensity of tan δ are controlled, in some cases, wear resistance is unsatisfactory under high-temperature, high-humidity conditions (HH conditions).

Therefore, there is demand for a blade exhibiting small variation in physical properties with temperature and satisfactory wear resistance under temperature conditions found during use (particularly at high temperature).

### SUMMARY OF THE INVENTION

In view of the foregoing, an object of the present invention is to provide a blade member which maintains cleaning performance, which does not generate squeaky sound, and which exhibits excellent wear resistance.

Accordingly, in a first mode of the present invention for attaining the object, there is provided a blade member formed of a polyurethane member produced through curing and molding a castable polyurethane composition containing at least a polyol, an isocyanate compound, and a cross-linking agent, wherein the polyurethane member exhibits a storage modulus (1 Hz) as measured at 40° C. of 2.0×10⁷ Pa or higher and a (G′10)/(G′50) of 3 or lower, wherein G′10 represents a storage modulus (1 Hz) as measured at 10° C. (Pa) and G′50 represents a storage modulus (1 Hz) as measured at 50° C. (Pa).

A second mode of the present invention is drawn to a specific embodiment of the blade member of the first mode, wherein the polyol has a molecular weight of 1,000 to 3,000.

A third mode of the present invention is drawn to a specific embodiment of the blade member of the first or second mode, wherein the polyol is polytetramethylene ether glycol (PTMG).

A fourth mode of the present invention is drawn to a specific embodiment of the blade member of any of the first to third modes, wherein the cross-linking agent contains a diamino compound having a melting point of 80° C. or lower.

A fifth mode of the present invention is drawn to a specific embodiment of the blade member of the fourth mode, wherein the diamino compound contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

A sixth mode of the present invention is drawn to a specific embodiment of the blade member of the first mode, wherein the polyurethane member contains mica in an amount of 1 to 10 parts by weight with respect to 100 parts by weight of the polyurethane composition; and mica is present in a ≧5% area of a cross-section of the blade member in the depth direction but is not present in a surface portion having a thickness of 10 μm as measured from the surface to be in contact with a contact object.

A seventh mode of the present invention is drawn to a specific embodiment of the blade member of the sixth mode, which contains mica in an amount of 5 to 10 parts by weight.

An eighth mode of the present invention is drawn to a specific embodiment of the blade member of the first mode, wherein the polyurethane member contains aggregates of a hard segment having an outer diameter of 0.5 μm or longer and shorter than 12 μm.

A ninth mode of the present invention is drawn to a specific embodiment of the blade member of the eighth mode, wherein the isocyanate compound is 1,5-naphthalene diisocyanate (NDI).

A tenth mode of the present invention is drawn to a specific embodiment of the blade member of any of the first to ninth modes, wherein the polyurethane member exhibits a storage modulus (1 Hz) as measured at 40° C. of 3.0×10⁷ Pa or higher.

### BRIEF DESCRIPTION OF THE DRAWINGS

FIG. 1 is a graph showing a relationship between hardness and storage modulus of a conventional polyurethane rubber.

FIG. 2 is a graph showing a relationship between rebound resilience and storage modulus of a conventional polyurethane rubber.

FIG. 3 is a graph showing a relationship between tan δ peak temperature and storage modulus of a conventional polyurethane rubber.

FIG. 4 is a graph showing storage modulus of samples of the Examples and Comparative Examples.

### DESCRIPTION OF PREFERRED EMBODIMENTS

The present invention has been accomplished on the basis of the finding that the wear resistance and cleaning performance of the blade member are correlated not with rebound resilience, viscoelasticity, etc. but with storage modulus. In other words, the present invention has been accomplished on the basis of this new finding that wear resistance and cleaning performance of interest can be realized through molding polyurethane so that the molded product has a predetermined storage modulus.

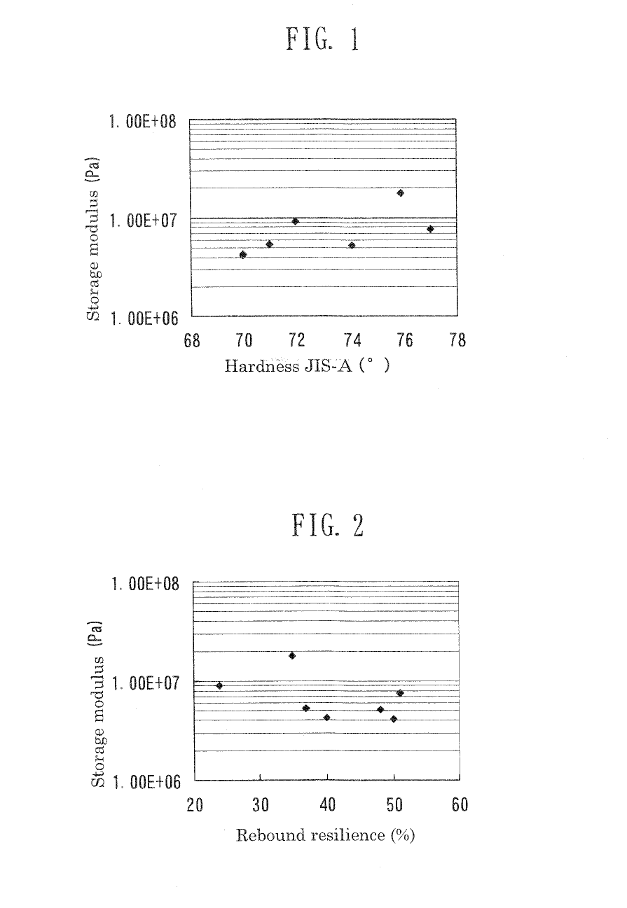

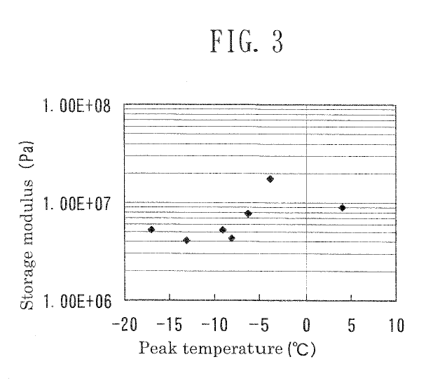

Next will be described that storage modulus is a characteristic parameter which differs from those conventionally employed. FIG. 1 is a graph showing a relationship between hardness and storage modulus of a conventional polyurethane rubber. FIG. 2 is a graph showing a relationship between rebound resilience and storage modulus of a conventional polyurethane rubber. FIG. 3 is a graph showing a relationship between tan δ peak temperature and storage modulus of a conventional polyurethane rubber. Note that the polyurethane rubber of FIGS. 1 to 3 is polyurethane conventionally employed for producing a cleaning blade member. As shown in FIGS. 1 to 3, there is no correlation between storage modulus and hardness, rebound resilience, or tan δ peak temperature. That is, storage modulus is entirely different from parameters such as hardness, rebound resilience, and tan δ peak temperature.

The blade member of the present invention is formed of a polyurethane member which exhibits a storage modulus (1 Hz) as measured at 40° C. of 2.0×10⁷ Pa or higher and a (G′10)/(G′50) of 3 or lower, wherein G′10 represents a storage modulus (1 Hz) as measured at 10° C. (Pa) and G′50 represents a storage modulus (1 Hz) as measured at 50° C. (Pa). Although the details will be described hereinbelow, the blade member has first been realized through appropriately adjusting the type and proportions of the polyol, the polyisocyanate, the cross-linking agent, etc.; incorporating a hard additive having high specific weight; and incorporating hard segment aggregates having predetermined dimensions in predetermined amounts. Thus, the blade member has a storage modulus higher than that of a conventional blade member and, particularly, exhibits a high storage modulus at an actual operation temperature (10° C. to 50° C.).

The polyurethane member exhibits a storage modulus (1 Hz) as measured at 40° C. of 2.0×10⁷ Pa or higher and a (G′10)/(G′50) of 3 or lower, wherein G′10 represents a storage modulus as measured at 10° C. (Pa) and G′50 represents a storage modulus as measured at 50° C. (Pa). Through controlling the storage modulus as measured at 40° C. to 2.0×10⁷ Pa or higher, more particularly 3.0×10⁷ Pa or higher, which is higher than that of a conventional blade member, excellent wear resistance and cleaning performance can be attained. Storage modulus is an index for evaluating vibration performance of a blade member. Specifically, a polyurethane member exhibiting high storage modulus can effectively attenuate vibration that is propagated via urethane bonds. Such a polyurethane member that satisfies the above conditions effectively prevents anomalous sound and filming of toner and additives. In addition, through controlling the (G′10)/(G′50) (G′10: storage modulus at 10° C. (Pa), G′50: storage modulus at 50° C. (Pa)) to 3 or lower, the polyurethane member exhibits small variation with environment. Thus, the member maintains consistent cleaning performance even when a change in the environment occurs.

The blade member is formed of a polyurethane member produced through curing and molding a castable polyurethane composition containing at least a polyol, an isocyanate compound, and a cross-linking agent. The polyurethane member is molded such that the storage modulus (1 Hz) as measured at 40° C. is adjusted to 2.0×10⁷ Pa or higher, and that the (G′10)/(G′50) (G′10: storage modulus 10° C., G′50: storage modulus at 50° C.) is adjusted to fall within a specific range.

The aforementioned storage modulus of the polyurethane member can be obtained through appropriately selecting the type and amount of the polyol, polyisocyanate, cross-linking agent, etc. and curing and molding under predetermined conditions. Specific examples of the methodology include increasing rigidity of soft segments, increasing rigidity of hard segments, and increasing the amounts of hard segments.

Examples of the polyol include polyester-polyols (produced through dehydration condensation between diol and dibasic acid), polycarbonate-polyols (produced through reaction between diol and alkyl carbonate), caprolactone-type polyols, and polyether-polyols. Of these, polytetramethylene ether glycol (PTMG) is preferred. The polyol preferably has a molecular weight of 1,000 to 3,000. Notably, when a polytetramethylene ether glycol (PTMG) having a molecular weight of 1,000 to 1,500 is used, storage modulus can be elevated in a relatively simple manner. A plurality of polyol species may be used in combination, so long as mechanical properties of the blade are not impaired.

The polyisocyanate reacted with the polyol preferably has a relatively non-rigid molecular structure. Examples of such polyisocyanates include 4,4′-diphenylmethane diisocyanate (MDI), 2,6-toluene diisocyanate (TDI), 1,6-hexane diisocyanate (HDI), 1,5-naphthalene diisocyanate (NDI), and 3,3-dimethylphenyl-4,4-diisocyanate (TODI). Of these, MDI and NDI are particularly preferred. The polyisocyanate content of the polyurethane is preferably 30 to 80 wt. %. When the polyisocyanate content is less than 30 wt. %, tensile strength may be poor, whereas when the content is in excess of 80 wt. %, permanent elongation may increase excessively.

Examples of the cross-linking agent include diols (2-function), triols (3-function), and tetraols (4-function). Needless to say, these cross-linking agents may be used in combination. An amine compound may also be used as a cross-linking agent.

No particular limitation is imposed on the diol, and examples of the diol include propanediol (PD) and butanediol (BD). Also, no particular limitation is imposed on the triol, and a triol having a molecular weight of 120 to 2,500 is preferred, with a triol having a molecular weight of 120 to 1,000 being more preferred. Specific examples include short-chain triols such as trimethylolethane (TME) and trimethylolpropane (TMP), and caprolactone-type triols (triols synthesized from ε-caprolactone) having a larger molecular weight and represented by the following formula (1). The triol is added in order to improve characteristics such as creep and stress relaxation.

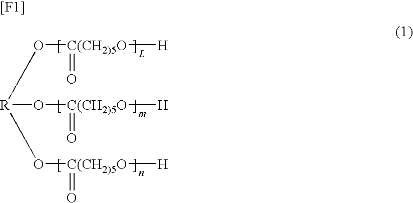

(R represents an alkyl group.)

Examples of the amine compound include a diamino compound. The diamino compound preferably has a melting point of 80° C. or lower. Through employment of such a diamino compound, storage modulus can be elevated in a relatively simple manner. The reason for controlling the melting point to 80° C. or lower is that the composition must be heated to a temperature equal to or higher than the melting point of the diamino compound during reaction, and if the reaction temperature is 80° C. or higher pot life of the reaction system is considerably shortened When the pot life of the composition is shortened, the composition cannot be molded or dimensional precision of the molded products is impaired. As used herein, the term “pot life” refers to a period of time during which the relevant material has comparatively low viscosity and maintains fluidity. In addition, preferably, the diamino compound contains no chlorine atom but contains an aromatic ring in the molecular structure thereof and exhibits a reaction rate slower than that of 2,2′,3,3′-tetrachloro-4,4′-diaminodiphenylmethane (diamino compound) under given hardening and molding conditions. Since the aforementioned diamino compound contains no chlorine atom, the compound has substantially no steric hindrance, whereas since the compound has an aromatic ring, polyurethane hardened with the diamino compound exhibits small variation in physical properties with temperature, excellent mechanical strength, and excellent wear resistance. When a diamino compound exhibiting a reaction rate slower than that of 2,2′,3,3′-tetrachloro-4,4′-diaminodiphenylmethane is employed in production of polyurethane, failure of sheet formation due to excessively fast reaction rate can be prevented.

Among diamino compounds, at room temperature, some assume a liquid form and others assume a solid form. Of these, liquid-form diamino compounds are preferred. Examples of the diamino compound satisfying the conditions include diaminodiphenylmethane compounds and phenylenediamine compounds. Specific examples include 4,4′-methylenedianiline (DDM), 3,5-dimethylthio-2,4-toluenediamine (DMTDA), 2,4-toluenediamine (2,4-TDA), 2,6-toluenediamine (2,6-TDA) methylenebis(2-ethyl-6-methylamine), 1,4-di-sec-butylaminobenzene, 4,4-di-sec-butylaminediphenylmethane, 1,4-bis(2-aminophenyl)thiomethane, diethyltoluenediamine, trimethylenebis(4-aminobenzoate), and polytetramethylene oxide di-p-aminobenzoate.

No particular limitation is imposed on the amount of cross-linking agent in the polyurethane member. The tri-functional cross-linking agent content of the cross-linking agent is preferably 0 to 60%, more preferably 5 to 40%. Notably, the bi-functional cross-linking agent and the tri-functional cross-linking agent may be used in combination, and two or more bi-functional cross-linking agents, or two or more tri-functional cross-linking agents may be used in combination.

Preferably, the polyurethane member forming the cleaning layer and that forming the elastic layer both have an α value of 0.7 to 1.0, particularly preferably 0.90 to 0.98. The term “α value” refers to a value calculated by the following equation. When the α value is more than 1.0, functional groups (e.g., a hydroxyl group and an amino group) of the cross-linking agent remain and stain a photoreceptor of a similar member which the blade contacts, whereas when the α value is less than 0.7, crosslinking density may excessively decrease, resulting in poor mechanical strength, or may stain a photoreceptor due to the long period of time required for the deactivation of remaining isocyanate groups.

α value=(amount (mol) of functional groups in cross-linking agent)/(amount (mol) of isocyanate groups remaining after reaction between polyol and polyisocyanate)

The K value (the number of NCO groups in polyurethane material/the number of OH groups of the long-chain polyol in polyurethane material) is preferably 2.0 to 6.0, more preferably 2.0 to 3.9. When the K value is less than 2.0, the hard segment amount is excessively small, thereby reducing the strength of polyurethane due to excessively high flexibility. Thus, in some cases, elevating friction coefficient. When the K value is greater than 6.0, the hard segment amount is excessive, sufficient flexibility cannot be attained. Thus, in some cases, friction coefficient decreases.

The aforementioned storage modulus can also be attained through incorporating a hard additive having a high specific weight into the polyol, isocyanate, and cross-linking agent. Examples of suitably employed additives include mica. Specifically, through incorporating a predetermined amount of mica into the polyurethane composition, and causing the added mica to be present in a predetermined portion of the blade member, the blade member can possess a storage modulus falling within the aforementioned range. When mica is incorporated in an amount of 1 to 10 parts by mass (preferably 5 to 10 parts by mass) into 100 parts by mass of polyurethane composition, storage modulus can be elevated to prevent generation of squeaky sound, without causing an increase in hardness of the polyurethane member and a considerable drop in mechanical characteristics of the member. Notably, when the amount of mica incorporated into the composition is less than 1 part by mass, the effect of mica cannot be attained sufficiently, whereas when the amount of mica is in excess of 10 parts by mass, the amount of urethane bonds decreases. In this case, edge drooping resistance is impaired, and the pressure of the blade applied to objects gradually decreases, thereby failing to attain desired cleaning performance.

Mica is added to the blade member in such a manner that mica is present in a ≧5% area of a cross-section of the blade member in the depth direction but is riot present in a surface portion having a thickness of 10 μm as measured from the surface to be in contact with a contact object. By virtue of this feature, squeaky sound can be prevented, and excellent cleaning performance can be maintained. Mica may be present in any portion of the blade member except for the surface portion having a thickness of 10 μm as measured from the surface to be in contact with a contact object. For example, mica may be localized in a backside portion (opposite the contact surface side) of the blade member or uniformly dispersed in the blade member other than the surface portion having a thickness of 10 μm. When mica is present in a <5% area of a cross-section of the blade member in the depth direction, the effect of mica on prevention of squeaky sound cannot be attained sufficiently, whereas when mica is present in a surface portion having a thickness of 10 μm as measured from the surface to be in contact with a contact object, cleaning performance decreases.

Mica particles assume flat and generally ellipsoidal shapes. The average particle size (flat surface diameter) of mica particles is preferably 340 μm or less. The term “diameter” refers to a longer diameter. When the average particle size of mica is in excess of 340 μm, mechanical characteristics of the blade member may be impaired, and bonding strength to a counter member may decrease. The species of mica may be any of gold mica, white mica, black mica, etc.

The aforementioned storage modulus can be attained through molding to a polyurethane member containing hard segment aggregates having appropriate dimensions. As used herein, the term “hard segment aggregates” refers to aggregates predominantly containing hard segments formed mainly through reaction between short polymer chains. In some cases, portions of the aggregates may contain soft segments. In other words, hard segment aggregates mainly contain a self-addition product of the isocyanate compound, a self-addition product of the cross-linking agent, and a reaction product of the isocyanate compound and the cross-linking agent and, in some cases, contain a long-chain polyol. Such hard segment aggregates, which can be observed under a microscope or a similar device, have an outer diameter of 0.5 μm or longer and shorter than 12 μm, preferably 1 to 10 μm. A polyurethane member molded so as to contain hard segment aggregates having an outer diameter of 0.5 μm or longer and shorter than 12 μm exhibits both chipping resistance and wear resistance. The polyurethane member is produced through mixing a polyol, an isocyanate compound, a cross-linking agent, etc. and molding under such conditions where uniform molecular orientation is obtained. Specifically, a polyurethane composition is prepared under the conditions where vulcanization is retarded through, for example, lowering the temperature of polyol and prepolymer and/or curing/molding temperature. However, when these temperatures (temperature of polyol and prepolymer arid/or curing/molding temperature) are set to excessively low levels, the outer diameter of hard segment aggregates may increase to 12 μm or longer. Therefore, these temperature are appropriately controlled so as to obtain hard segment aggregates of interest.

The polyurethane member may be produced through a production method for polyurethane generally employed in the art, such as the pre-polymer method or the one-shot method. The prepolymer method is preferred in the present invention, since the method can produce a polyurethane having excellent strength and wear resistance. However, no particular limitation is imposed on the production method. Notably, when mica is used, centrifugal molding is preferably employed, since a desired dispersion state of mica can be easily attained through controlling of the rotation rate of a rotatable drum of a centrifugation molding apparatus The blade member of the present invention is suitably employed as a cleaning blade member for cleaning an electrophotographic photoreceptor; an image-transfer drum and belt employed in image transfer; and an intermediate transportation belt. However, the use thereof is not limited thereto, and the blade member is also suitable as a toner-controlling blade, a metal-cleaning roller, etc.

The present invention will next be described in details by way of examples, which should not be construed as limiting the invention thereto.

### Example

### Example 1

A polyester diol having a molecular weight of 2,000 was produced from adipic acid and a mixture of 1,9-nonanediol. (ND) and 2-methyl-1,8-octanediol (MOD). The polyester diol (100 parts by mass) and 4,4′-diphenylmethane diisocyanate (MDI) (50 parts by mass) were mixed to give a prepolymer. To the prepolymer maintained at a predetermined temperature, 1,3-propanediol (PD) and trimethylolethane (TME) were added in such amounts that the α value and K value were adjusted to 0.95 and 4.0, respectively, and the tri-functional content (mole ratio) of the cross-linking agent was adjusted to 0.3. Mica (8.5 parts by mass) was further added to the mixture. The resultant mixture was allowed to react at a predetermined temperature for curing, to thereby form a polyurethane sheet. The polyurethane sheet was cut to give test samples of Example 1 and cleaning blade members of Example 1 having a thickness of 2.0 mm.

In each test sample, mica was present in a ≧5% area of a cross-section of the blade member in the depth direction but is not present in a surface portion having a thickness of 10 μm as measured from the surface to be in contact with a contact object.

### Example 2

Polyoxytetramethylene ether glycol (PTMG) having a molecular weight of 1,400 (100 parts by mass) and 4,4′-diphenylmethane diisocyanate (MDI) (60 parts by mass) were mixed to give a prepolymer. To the prepolymer maintained at a predetermined temperature, 1,4-butanediol (1,4-BD) and trimethylolpropane (TMP) were added in such amounts that the α value and K value were adjusted to 0.95 and 3.4, respectively, and the tri-functional content (mole ratio) of the cross-linking agent was adjusted to 0.2. The resultant mixture was allowed to react at a predetermined temperature for curing, to thereby form a polyurethane sheet. The polyurethane sheet was cut to give test samples and cleaning blade members of Example 2.

### Example 3

A prepolymer was produced from a polyol (molecular weight: 1,000) (60 parts by mass) produced from adipic acid and a mixture of 1,9-nonanediol (ND) and 2-methyl-1,8-octanediol (MOD); a polyol (molecular weight: 2,000) (40 parts by mass) produced from adipic acid and a mixture of 1,9-nonanediol (ND) and 2-methyl-1,8-octanediol (MOD); and 1,5-naphthalene diisocyanate (NDI) (40 parts by mass). To the prepolymer maintained at a predetermined temperature, 1,4-butanediol (1,4-BD) and trimethylolpropane (TMP) were added in such amounts that the α value and K value were adjusted to 0.95 and 2.4, respectively, and the tri-functional content (mole ratio) of the cross-linking agent was adjusted to 0.5. The resultant mixture was allowed to react at a temperature 20° C. lower than that employed in Example 1, to thereby form a polyurethane sheet. The polyurethane sheet was cut to give test samples and cleaning blade members of Example 3.

The polyurethane sheet was observed under a microscope (product of KEYENCE Corporation, magnification: ×450). 24 hard segment aggregates were observed in a 1,000 μm² area. All the hard segment aggregates were found to be smaller than 12 μm, and to have an average outer diameter of 3.2 μm. Each of the average outer diameter of the hard segment aggregates and the number of hard segment aggregates in a 1,000 μm² area was an average value of three measurements determined at different positions.

### Example 4

A prepolymer was produced from a polyol (molecular weight: 2,000) (100 parts by mass) produced from adipic acid and a mixture of 1,9-nonanediol (ND) and 2-methyl-1,8-octanediol (MOD); and 4,4′-diphenylmethane diisocyanate (MDI) (50 parts by mass). To the prepolymer maintained at a predetermined temperature, 1,4-butanediol (BD), dimethylthiotoluenediamine (DMTDA), and trimethylolpropane (TMP) were added in such amounts that the α value and K value were adjusted to 0.95 and 4.0, respectively, and the tri-functional content (mole ratio) of the cross-linking agent was adjusted to 0.05. The resultant mixture was allowed to react at a predetermined temperature, to thereby form a polyurethane sheet. The polyurethane sheet was cut to give test samples and cleaning blade members of Example 4.

### Comparative Example 1

The procedure of Example 1 was repeated, except that no mica was added to polyurethane, to thereby produce test samples and cleaning blade members of Comparative Example 1.

### Comparative Example 2

The procedure of Example 2 was repeated, except that 4,4′-diphenylmethane diisocyanate (MDI) was used in an amount of 65 parts by mass, and the tri-functional content (mole ratio) of the cross-linking agent was adjusted to 0.25, to thereby produce test samples and cleaning blade members of Comparative Example 2.

### Comparative Example 3

The procedure of Example 3 was repeated, except that the molding temperature was elevated by 20° C., to thereby produce test samples and cleaning blade members of Comparative Example 3.

### Comparative Example 4

The procedure of Example 4 was repeated, except that no dimethylthiotoluenediamine (DMTDA) was added to polyurethane, to thereby produce test samples and cleaning blade members of Comparative Example 4.

### Test Example 1

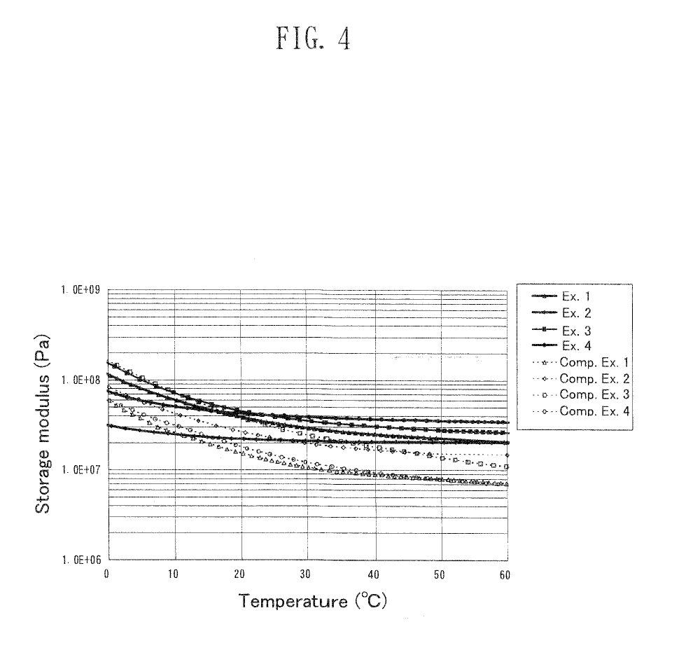

Physical properties of the test samples of the Examples and Comparative Examples were determined. Rubber hardness (JIS A) (25° C.) was determined in accordance with JIS K6301. Tensile strength at 100% elongation (100% M), tensile strength at 200% elongation (200% M), and tensile strength at 300% elongation (300% M) were determined in accordance with JIS K6251. Tensile strength and elongation at break were determined in accordance with JIS K6251. Tear strength was determined in accordance with JIS K6252. Young's modulus (25% elongation) was determined in accordance with JIS K6254. Storage modulus (1 Hz) was determined by means of EXSTAR 6000 (product of SII) The results are shown in Table 2 and FIG. 4.

### Test Example 2

As a cleaning blade, each of the blade members produced in the Examples and Comparative Examples was attached to a commercial plain paper copying machine (employing polymer toner and an organic photoreceptor) On one sheet of card-board, a chart bearing a percent toner printing area of 1% was printed at a temperature of 30° C. and a humidity of 85%. The operation was repeated sheet by sheet for 60 minutes. And then, squeaky sound was aurally checked in a print mode shown in Table 1.

TABLE 1

| | Test 1 | Test 2 |
|---|---|---|
| Color mode | full color | monochrome |
| Type of paper sheet | card-board | plain paper sheet |

In Tests 1 and 2, squeaky sound was evaluated with the following ratings: ◯ (no squeaky sound), Δ (squeaky sound generated in Test 1), and X (squeaky sound generated in Tests 1 and 2).

After checking of squeaky sound, the wear state of an edge of each blade member was observed under a microscope, and the cross-sectional area corresponding to wear portions were measured. Wear resistance was evaluated with the following ratings: ◯ (average wear cross-section of <10 μm²), Δ (average wear cross-section of 10 to 20 μm²), and X (average wear cross-section of >20 μm²).

Also, after the printing tests, the cleaning performance of each blade member was evaluated. After printing, the image pattern printed on each sheet and the surface of the photo receptor were visually checked and evaluated with the following ratings: ◯ (satisfactory cleaning performance) and X (not cleaned). The measurement conditions are described hereinbelow, and Table 2 shows the test results.

Also, after the printing tests, the cleaning performance of each blade member was evaluated. After printing, the image pattern printed on each sheet and the surface of the photo receptor were visually checked and evaluated with the following ratings: ◯ (satisfactory cleaning performance) and X (not cleaned).

### <Laser Microscopy Conditions>

Microscope: VK-9500 (KEYENCE Corporation),
magnification: ×10

Mode: Ultra-depth color profiling

Measurement points: 5 points per cleaning blade (i.e., points 20 mm from the respective ends, points 80 mm from the respective ends, and the center point)

TABLE 2

| | Ex. 1 | Ex. 2 | Ex. 3 | Ex. 4 | Comp. 1 | Comp. 2 | Comp. 3 | Comp. 4 |
|---|---|---|---|---|---|---|---|---|
| Polyol | 1,9-ND/ | PTMG | 1,9-ND/ | 1,9-ND/ | 1,9-ND/ | PTMG | 1,9-ND/ | 1,9-ND/ |
| | MOD | | MOD | MOD | MOD | | MOD | MOD |
| Mol. wt. of polyol | 2000 | 1400 | 1000/2000 | 2000 | 2000 | 1400 | 1000/2000 | 2000 |
| Isocyanate | MDI | MDI | NDI | MDI | MDI | MDI | NDI | MDI |
| Isocyanate (parts) | 50 | 60 | 40 | 50 | 50 | 65 | 40 | 50 |
| 2-Functional cross- | PD | BD | BD | PD/DMT | PD | BD | BD | BD |
| linking agent | | | | DA | | | | |
| 3-Functional cross- | TME | TMP | TMP | TMP | TME | TMP | TMP | TMP |
| linking agent | | | | | | | | |
| 3-function content of | 0.30 | 0.20 | 0.50 | 0.05 | 0.30 | 0.25 | 0.50 | 0.15 |
| cross-linking agent | | | | | | | | |
| (mole) | | | | | | | | |
| Other additives | mica | — | — | diamino | — | — | — | — |
| | | | | compd. | | | | |

| Items | Method | Ex. 1 | Ex. 2 | Ex. 3 | Ex. 4 | Comp. 1 | Comp. 2 | Comp. 3 | Comp. 4 |
|---|---|---|---|---|---|---|---|---|---|
| Hardness | JIS K6301 | 78 | 81 | 78 | 78 | 77 | 79 | 77 | 80 |
| (°) | | | | | | | | | |
| Rebound | JIS K6301 | 22 | 47 | 27 | 44 | 27 | 27 | 22 | 34 |
| resilience | | | | | | | | | |
| (%) | | | | | | | | | |
| 100% M | JIS K6251 | 10 | 8 | 5 | 7 | 9 | 7 | 5 | 9 |
| (MPa) | | | | | | | | | |
| 200% M | JIS K6251 | — | 15 | 9 | 11 | 20 | 16 | 8 | 18 |
| (MPa) | | | | | | | | | |
| 300% M | JIS K6251 | — | 31 | 27 | 21 | — | — | 25 | 41 |
| (MPa) | | | | | | | | | |
| Tensile | JIS K6251 | 15 | 34 | 42 | 49 | 39 | 30 | 44 | 48 |
| strength at | | | | | | | | | |
| break (MPa) | | | | | | | | | |
| Elongation | JIS K6251 | 170 | 310 | 330 | 410 | 260 | 270 | 325 | 310 |
| at break | | | | | | | | | |
| (%) | | | | | | | | | |
| Tear | JIS K6252 | 56 | 71 | 61 | 94 | 74 | 65 | 64 | 84 |
| strength | | | | | | | | | |
| (KN/m) | | | | | | | | | |
| Young's | JIS K6254 | 10.9 | 12.1 | 9.2 | 10.0 | 9.8 | 9.5 | 8.2 | 12.5 |
| modulus | | | | | | | | | |
| (MPa) | | | | | | | | | |

| | Ex. 1 | Ex. 2 | Ex. 3 | Ex. 4 | Comp. 1 | Comp. 2 | Comp. 3 | Comp. 4 |
|---|---|---|---|---|---|---|---|---|
| G′10 (1 Hz) (Pa) | 5.9E+07 | 2.5E+07 | 7.2E+07 | 5.1E+07 | 2.6E+07 | 4.7E+07 | 7.8E+07 | 3.0E+07 |
| G′40 (1 Hz) (Pa) | 2.5E+07 | 2.1E+07 | 3.1E+07 | 3.7E+07 | 8.9E+07 | 1.7E+07 | 1.9E+07 | 9.2E+06 |
| G′50 (1 Hz) (Pa) | 2.3E+07 | 2.1E+07 | 2.8E+07 | 3.6E+07 | 8.0E+07 | 1.4E+07 | 1.4E+07 | 7.9E+06 |
| G′10/G′50 | 2.60 | 1.19 | 2.58 | 1.42 | 3.23 | 3.28 | 5.68 | 3.86 |
| Squeaky sound | ◯ | ◯ | ◯ | ◯ | Δ | Δ | Δ | X |
| Wear resistance | ◯ | ◯ | ◯ | ◯ | Δ | Δ | Δ | X |
| Cleaning performance | ◯ | ◯ | ◯ | ◯ | ◯ | X | X | X |

### Results

All the test samples of Examples 1 to 4, having a storage modulus of 2.0×10⁷ Pa or higher and a (G′10)/(G′50) of 3 or less, were found to have mechanical characteristics suitable for use as a cleaning blade member. The cleaning blade members of Examples 1 to 4 generated no squeaky sound, had high wear resistance, and exhibited excellent cleaning performance.

In contrast, although the test samples of Comparative Examples 1 to 4, having a (G′10)/(G′50) greater than 3, had satisfactory mechanical characteristics, the cleaning blade members of Comparative Examples 1 to 4 had poor wear resistance. Thus, the cleaning blade members did not have a long service life. All the cleaning blade members of the Comparative Examples generated squeaky sound in the tested machine.

Therefore, a cleaning blade member having a storage modulus of 2.0×10⁷ Pa or higher and a (G′10)/(G′50) of 3 or lower was found to generate no squeaky sound in operation, to have high wear resistance, and to exhibit excellent cleaning performance.

1. A blade member formed of a polyurethane member produced through curing and molding a castable polyurethane composition containing at least a polyol, an isocyanate compound, and a cross-linking agent, wherein the polyurethane member exhibits a storage modulus (1 Hz) as measured at 40° C. of 2.0×10⁷ Pa or higher and a (G′10)/(G′50) of 3 or lower, wherein G′10 represents a storage modulus (1 Hz) as measured at 10° C. (Pa) and G′50 represents a storage modulus (1 Hz) as measured at 50° C. (Pa).

2. A blade member according to claim 1, wherein the polyol has a molecular weight of 1,000 to 3,000.

3. A blade member according to claim 2, wherein the polyol is polytetramethylene ether glycol (PTMG).

4. A blade member according to claim 1, wherein the cross-linking agent contains a diamino compound having a melting point of 80° C. or lower.

5. A blade member according to claim 4, wherein the diamino compound contains no chlorine atom but contains an aromatic ring in the molecular structure thereof and exhibits a reaction rate slower than that of 2,2′,3,3′-tetrachloro-4,4′-diaminodiphenylmethane under given hardening and molding conditions.

6. A blade member according to claim 1, wherein the polyurethane member contains mica in an amount of 1 to 10 parts by weight with respect to 100 parts by weight of the polyurethane composition; and mica is present in a ≧5% area of a cross-section of the blade member in the depth direction but is not present in a surface portion having a thickness of 10 μm as measured from the surface to be in contact with a contact object.

7. A blade member according to claim 6, which contains mica in an amount of 5 to 10 parts by weight.

8. A blade member according to claim 1, wherein the polyurethane member contains aggregates of a hard segment having an outer diameter of 0.5 μm or longer and shorter than 12 μm.

9. A blade member according to claim 8, wherein the isocyanate compound is 1,5-naphthalene diisocyanate (NDI).

10. A blade member according to claim 1, wherein the polyurethane member exhibits a storage modulus (1 Hz) as measured at 40° C. of 3.0×10⁷ Pa or higher.
